(19) United States
(12) Patent Application Publication
(10) Pub. No.: US 2019/0045707 A1
(43) Pub. Date: Feb. 14, 2019

(54) LAWN MOWER BLADE ARRANGEMENTS

(71) Applicant: Arthur Gary Patridge, Advance, NC (US)

(72) Inventor: Arthur Gary Patridge, Advance, NC (US)

(21) Appl. No.: 15/674,880

(22) Filed: Aug. 11, 2017

(51) Int. Cl. A01D 34/73; A01D 34/66; A01D 34/00

(52) U.S. Cl. CPC A01D 34/73; A01D 34/005; A01D 34/66

(57) ABSTRACT

A multi-blade mower includes at least two spindles spaced apart from each other. In one example implementation, two blades are mounted at different heights on each respective spindle, and the blades at each spindle have different lengths. Horizontal clearance is provided between the lower blades, and the cutting circle of one of the upper blades overhangs the clearance zone between the lower blades, so that any grass missed between the lower blades is cut by the overhanging upper blade. The two blades on each spindle are spaced apart by a blade spacer between the blades.

### CROSS REFERENCE TO RELATED APPLICATIONS

This application is related to U.S. patent application Ser. No. 15/008,173 filed Jan. 27, 2016, now U.S. Pat. No. 9,480,200, titled “Multi-Blade Lawn Mower Cutting System With Overlapping Cutting Circles” and issued Nov. 1, 2016, the entire disclosure of which is hereby incorporated by reference herein for all purposes.

### BACKGROUND OF THE INVENTION

Power lawn mowers are widely used to maintain and enhance the appearance of turf grass and other vegetation. In one simple arrangement, a generally rectangular blade is rotated in a horizontal plane at the desired cutting height. The blade sweeps out a circle, and sharpened cutting zones on the leading edges of the blade cut the grass at the desired height as the entire mower travels across the lawn. The blade may also include raised “wings” on its trailing edges, to lift the grass as it is cut by the sharpened edges. In a single-blade mower, the blade may typically be about three inches across and 18-24 inches long, so that the mower cuts a swath about 18-24 inches wide. The blade may be turned by a motor such as a gasoline or electric motor, and in some mowers, power from the motor is also be used to propel the mower itself. Often, the blade is attached directly to the vertical shaft of the motor.

While such a narrow swath may be satisfactory for cutting small areas, it is often desirable for a mower to cut a wider swath, to reduce the time required to mow a larger area. Because various difficulties arise when a mower blade exceeds about 24 inches, multi-blade mowers have been developed. In a typical multi-blade mower, multiple blades rotate on spaced-apart spindles, each spindle having a single blade mounted thereon, and are transported in parallel across the lawn. The blades of conventional multi-blade mowers are oriented in the same plane and are commonly offset or timed to provide horizontal overlap between the blade swaths. The blades cut an overall swath that approaches the sum of the lengths of the blades, less the overlap necessary to ensure that no gaps exist in the cut swath. That is, a two-blade mower may cut a swath just under twice the width of a mower having a single blade of the same length as each of the two blades. A multiple-blade mower thus achieves improved cutting productivity, while avoiding the difficulties of longer blades. The blades are typically housed within a single deck that has internal baffling that works to minimize conflicting airflow between adjacent blades and also to direct and expedite the discharge of cut clippings from within the deck.

There is a need for improved multi-blade mowers.

### BRIEF SUMMARY OF THE INVENTION

According to one aspect, a mower comprises a spindle, a lower blade defining a first pair of through holes spaced apart by a first distance, and an upper blade defining a second pair of through holes spaced apart by a second distance different from the first distance. A spacer is disposed between the first lower and first upper blades. The spacer is at least partially flat and defines a pattern of through holes for receiving fasteners to connect the lower blade, the spacer, and the upper blade into an integrated unit with the lower and upper blades separated vertically from each other by a distance equal to a thickness of the spacer. The hole pattern comprises a third first pair of through holes spaced apart by the first distance for attaching the lower blade, and a fourth pair of through holes spaced apart by the second distance for attaching the upper blade. In some embodiments, the pattern of through holes is such that when the lower blade, the spacer, and the upper blade are assembled into the integrated unit, the lower and upper blades are fixed in an angular relationship such that one leads the other in rotation of the spindle. In some embodiments, the spacer further defines a central drive feature for receiving the spindle, the drive feature preventing rotation of the spacer with respect to the spindle. The drive feature may be a hole with at least one flat side or shaped to receive a splined shaft. In some embodiments, the upper and lower blades are of unequal length. In some embodiments, the mower further comprises a plurality of fan blades attached to the spacer. At least some of the fan blades may have a shape that promotes mulching of cut grass clippings.

According to another aspect, a multi-blade mower comprises first and second spindles spaced apart from each other by a distance, and a first lower blade and a first upper blade mounted to the first spindle, wherein the first upper blade is mounted higher than the first lower blade. The mower further comprises a second lower blade and a second upper blade mounted to the second spindle, wherein the second lower blade is at the same height as the first lower blade, wherein the second upper blade is mounted higher than the second lower blade. The mower further comprises a first spacer between the first lower and first upper blades. The first spacer defines a pattern of through holes for receiving fasteners to connect the first lower blade, the first spacer, and the first upper blade into a first integrated unit with the first lower and first upper blades separated vertically from each other by a distance equal to a thickness of the first spacer. The mower further comprises a second spacer between the second lower and second upper blades. The second spacer defines a pattern of through holes for receiving fasteners to connect the second lower blade, the second spacer, and the second upper blade into a second integrated unit with the second lower and second upper blades separated vertically from each other by a distance equal to a thickness of the second spacer. In some embodiments, the first upper blade is longer than the first lower blade and sweeps out a larger circle than the first lower blade sweeps out during rotation; the second upper blade is shorter than the second lower blade and sweeps out a smaller circle than the second lower blade sweeps out during rotation; and the circles swept out by the first and second lower blades do not overlap, and the circles swept out by the first upper blade and the second lower blade do overlap, as viewed from above the mower. In some embodiments, each of the first and second spacers is at least partially flat. In some embodiments, the first spacer and the second spacer are identical to each other, have an asymmetrical hole pattern, and are assembled to their respective spindles such that the first and second spacers are inverted with respect to each other. In some embodiments, the hole pattern in each of the first and second spacers comprises a first pair of holes spaced apart by a first distance for attaching the respective longer blade, and a second set of holes spaced apart by a second distance different from the first for attaching the respective shorter blade. In some embodiments, each of the first and second spacers further defines a central drive feature for receiving the respective first or second spindle, the drive feature preventing rotation of the spacer with respect to the received spindle. Each drive feature may be a hole with at least one flat side or shaped to receive a splined shaft. In some embodiments, the mower further comprises a plurality of fan blades, wherein the fan blades are attached to the first spacer, or the fan blades are attached to the second spacer, or some of the fan blades are attached to the first spacer and some of the fan blades are attached to the second spacer. At least some of the fan blades may have a shape that promotes mulching of cut grass clippings.

According to another aspect, a multi-blade mower comprises first and second spindles spaced apart from each other by a distance, and a first lower blade and a first upper blade mounted to the first spindle. The first upper blade is mounted higher than the first lower blade, and the first upper blade is longer than the first lower blade and sweeps out a larger circle than the first lower blade sweeps out during rotation. The first lower blade and the first upper blade are formed together from a first single piece of material. The multi-blade mower further comprises a second lower blade and a second upper blade mounted to the second spindle. The second lower blade is at the same height as the first lower blade, and the second upper blade is mounted higher than the second lower blade. The second upper blade is shorter than the second lower blade and sweeps out a smaller circle than the second lower blade sweeps out during rotation. The second lower blade and the second upper blade are formed together from a second single piece of material. The circles swept out by the first and second lower blades do not overlap, and the circles swept out by the first upper blade and the second lower blade do overlap, as viewed from above the mower.

According to another aspect, a multi-blade mower, comprises first and second spindles spaced apart from each other by a distance, and a first blade mounted to the first spindle. The first blade comprises a first set of upper cutting edges and a first set of lower cutting edges, the first sets of upper and lower cutting edges displaced rotationally about the first spindle. The first upper cutting edges are higher than the first lower cutting edges, and the first upper cutting edges extend farther from the first spindle than the first lower cutting edges and sweep out a larger circle than the first lower cutting edges sweep out during rotation of the first spindle. The first blade, including the first sets of upper cutting edges and lower cutting edges, is formed from a first single piece of material. The multi-blade mower further comprises a second blade mounted to the second spindle. The second blade comprises a second set of upper cutting edges and a second set of lower cutting edges, the second sets of upper and lower cutting edges being displaced rotationally about the second spindle. The second upper cutting edges are higher than the second lower cutting edges and the second set of lower cutting edges is at the same height as the first set of lower cutting edges. The second lower cutting edges extend farther from the second spindle than the second upper cutting edges and sweep out a larger circle than the second upper cutting edges sweep out during rotation of the second spindle. The second blade, including the second sets of upper cutting edges and lower cutting edges, is formed from a second single piece of material. The circles swept out by the first and second sets of lower cutting edges do not overlap, and the circles swept out by the first set of upper cutting edges and the second set of lower cutting edges do overlap, as viewed from above the mower. In some embodiments, the first and second spindles are not timed in relation to each other. In some embodiments, the first and second spindles are positioned on an axis that is perpendicular to a nominal direction of travel of the mower.

### BRIEF DESCRIPTION OF THE DRAWINGS

FIG. 1 illustrates a multi-blade mower having skewed spindles.

FIG. 2 illustrates a multi-blade mower having timed spindles.

FIG. 3 illustrates a mower blade arrangement in accordance with embodiments of the invention, as viewed along the direction of travel of the mower.

FIG. 4 shows an enlarged view of a portion of FIG. 3.

FIG. 5 shows the operation of the blade arrangement of FIG. 3, as viewed from above the mower.

FIG. 6 shows an enlarged view of a blade interaction in a multi-blade mower in accordance with other embodiments.

FIG. 7 illustrates an example way of fixing upper and lower mower blades to each other, in accordance with embodiments of the invention.

FIG. 8 shows a schematic overhead view of a riding mower according to embodiments of the invention.

FIG. 9 shows a mower blade arrangement in accordance with other embodiments of the invention, as viewed along the direction of travel of the mower.

FIG. 10 shows a partially exploded view of the blade arrangement of FIG. 9.

FIG. 11 illustrates a top view of an example embodiment of a blade spacer.

FIG. 12 shows first and second integrated blade/spacer units, in accordance with embodiments of the invention.

FIG. 13 shows a horizontally-exploded view of the integrated blade/spacer units of FIG. 12.

FIG. 14 shows a blade spacer in accordance with other embodiments of the invention.

FIG. 15 shows an integrated blade/spacer unit, using the spacer of FIG. 14.

FIG. 16 shows a top view of a blade spacer in accordance with other embodiments of the invention.

FIG. 17 shows a side view of the blade spacer of FIG. 16.

FIG. 18 illustrates the attachment of mower blades to the blade spacer of FIG. 16, to form an integrated blade/spacer unit.

FIG. 19 shows an end view of a fan blade, in accordance with embodiments of the invention.

FIG. 20 shows a side view of the fan blade of FIG. 19.

FIG. 21 shows an end view of a fan blade in accordance with other embodiments of the invention.

FIG. 22 shows a side view of the fan blade of FIG. 21.

FIG. 23 illustrates an oblique view of a set of mower blades according to another embodiment.

FIG. 24 shows an upper orthogonal view of the set of mower blades of FIG. 23.

FIG. 25 shows blades of FIG. 23 mounted to spindles under a mower deck, in accordance with embodiments of the invention.

### DETAILED DESCRIPTION OF THE INVENTION

In multi-blade mowers, it is desirable to maximize cutting area and to ensure complete cutting of the lawn while avoiding collisions between the multiple blades. To avoid blade collisions, there should be absolute clearance between adjacent blades. The nominal design should provide enough clearance to accommodate manufacturing tolerances in spindle positioning and blade lengths, distortion of the mower deck during use, and other factors, so that clearance always exists between the blades. Unless addressed, this running clearance results in a gap between the blade tips that can allow grass encountered at the point of blade path intersection to “slide through” and remain uncut, resulting in an unacceptable cut quality and appearance.

To avoid leaving grass uncut in this way, many multiple spindle cutting deck designs position the blade spindles farther apart than the blade length, so that the blades cannot reach each other regardless of their rotational positions. The lateral mounting axis of the spindles is then intentionally skewed to create overlapping blade tip circles between adjacent spindles as viewed from the mower's direction of travel. That is, one blade trails the other in the direction of mower travel, and is inset toward the mower center line in relation to the other blade.

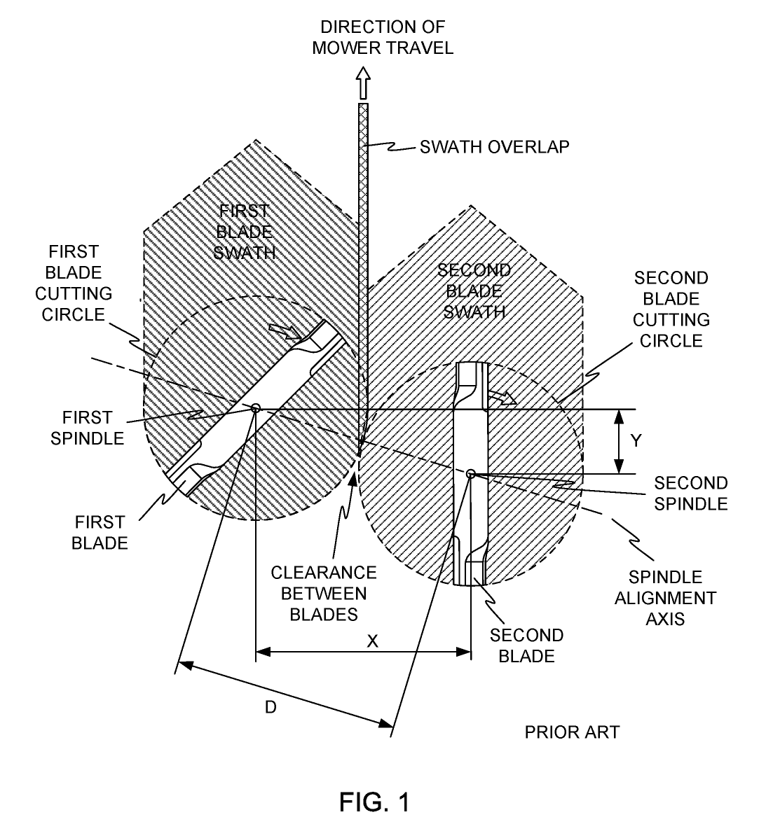

An example of skewed spindles is shown in FIG. 1. Two blades turn on respective spindles, and are at the same height relative to level ground. The two spindles are spaced from each other by a distance D sufficient to leave absolute clearance between the two blades. However, the spindles are placed on an alignment axis that is skewed with respect to the direction of mower travel, so that in the direction transverse to the mower travel, the spindles are spaced by distance X, and the second spindle trails the first by distance Y. Thus, the swaths cut by the two blades overlap as the mower moves.

In another arrangement, some mowers position the spindles closer together than the blade length, and ensure that the blades never collide by synchronizing or “timing” the rotation of adjacent blades in relation to each other. Thus, the cutting circles of the blades overlap, even if the spindles are not skewed in relation to the direction of travel. Typically, the blades are driven using cogged pulleys and toothed belts to avoid slippage of the pulleys with respect to each other on the belt, or a gear box is placed at each spindle and the gear boxes are coupled together in a fixed-ratio relationship.

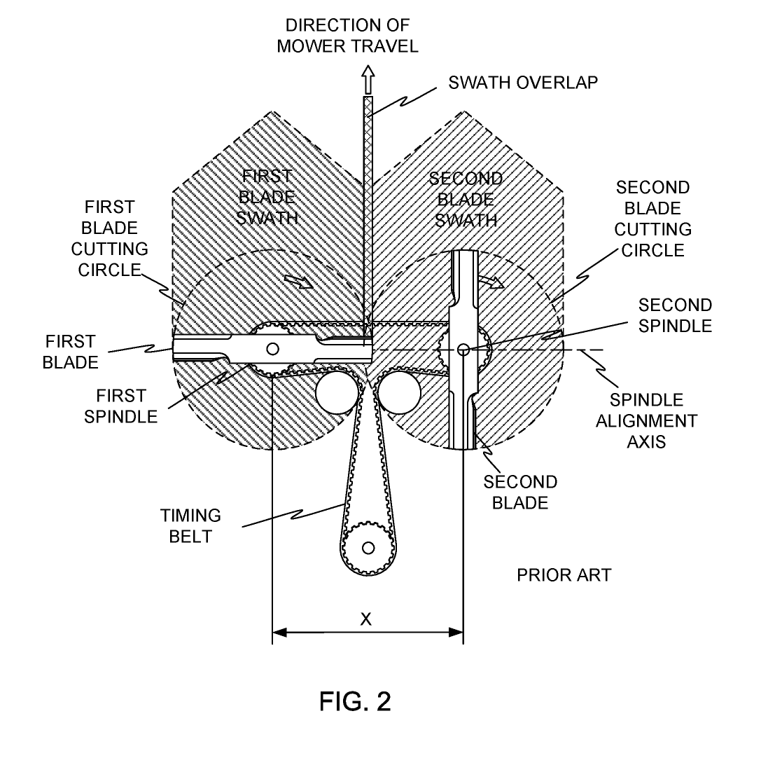

An example of timed blades is shown in FIG. 2. Again, two blades turn on respective spindles, and are at the same height relative to level ground. However, in FIG. 2, the spindles are placed on an axis that is not skewed with respect to the mower travel direction, but is transverse to it. The spindles are spaced apart by distance X, which is not sufficient to guarantee clearance between the blades. Rather, the blades are timed with respect to each other, using a timing belt and cogged pulleys, so that only one blade tip at a time can exist within the area of the blade circle overlap. Thus, the swaths cut by the two blades overlap, and the system relies on the timing mechanism to ensure that the blades do not collide.

Embodiments of the invention provide swath overlap in a novel way, using at least one additional blade displaced vertically from another of the cutting blades.

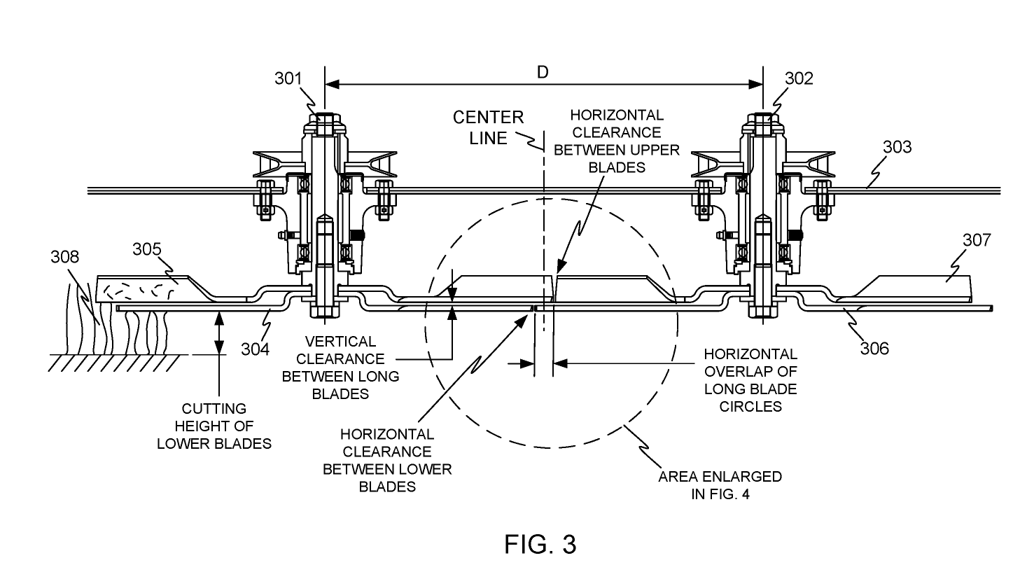

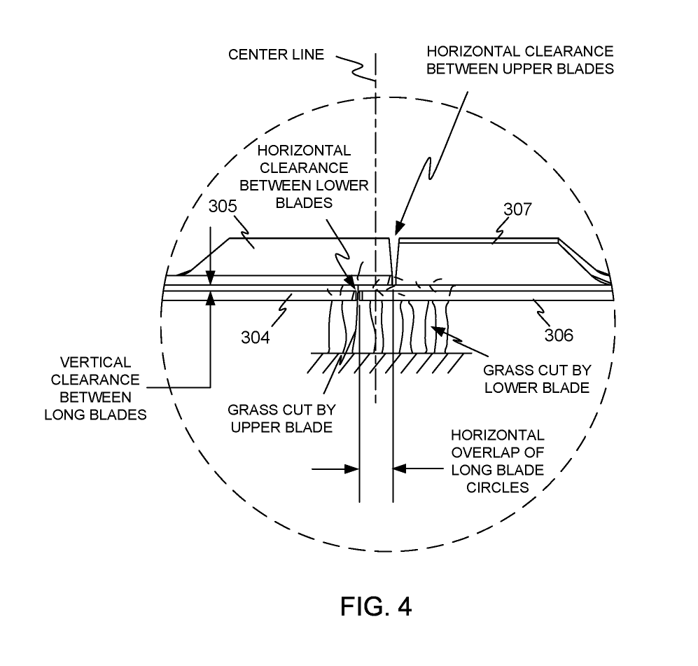

FIG. 3 illustrates a mower blade arrangement in accordance with some embodiments of the invention, as viewed along the direction of travel of the mower. FIG. 4 shows an enlarged view of a portion of FIG. 3. In the example of FIG. 3, a first spindle 301 and a second spindle 302 are spaced apart by a distance D. Spindles 301 and 302 are mounted to a mower deck 303, and turn on bearings.

In this example, four different blades are present, two mounted to each of spindles 301 and 302. A first lower blade 304 and a first upper blade 305 are mounted to and turn on first spindle 301. As can be seen in FIG. 3, first upper blade 305 is longer than first lower blade 304. (The blades on each spindle are shown in FIG. 3 as being aligned parallel with each other for ease of explanation, but this is not necessarily the case in practice. As is explained below in more detail, one blade on each axis may lead the other in rotation.) That is, the ends of first upper blade 305 overhang the ends of first lower blade 304, so that first upper blade 305 sweeps out a larger circle during rotation than does first lower blade 304.

A second lower blade 306 and a second upper blade 307 are mounted to and turn on second spindle 302. Second lower and upper blades 306 and 307 have the opposite length relationship from first lower and upper blades 304 and 305. As shown, second lower blade 306 is longer than second upper blade 307, such that second lower blade 306 sweeps out a larger circle during rotation than does second upper blade. In some embodiments the two longer blades (first upper blade 305 and second lower blade 306) may be equal in length, and the two shorter blades (first lower blade 304 and second upper blade 307) may be equal in length, but this is not a requirement.

Upper blades 305 and 307 are mounted higher than lower blades 304 and 306. For the purposes of this disclosure, blade height is the cutting height of the blade, for example as measured from the ground when the mower is resting on level ground. In the example of FIG. 3, first and second lower blades 304 and 306 are at the same height. As shown, first and second upper blades 305 and 307 are also mounted at the same height, but are mounted at a height higher than the height of the respective lower blades.

The circles swept out by lower blades 304 and 306 do not overlap. The lengths of lower blades 304 and 306 are such that the lower blades do not reach each other, regardless of the angular positions of the two lower blades. That is, there is absolute horizontal clearance between lower blades 304 and 306. Stated another way, each rotating blade sweeps out a circle having a respective radius, and the sum of radii of the circles swept out by lower blades 304 and 306 is smaller than the distance D between the spindles.

Similarly, the circles swept out by upper blades 305 and 307 do not overlap. The lengths of upper blades 305 and 307 are such that the upper blades do not reach each other, regardless of the angular positions of the two upper blades. That is, there is absolute horizontal clearance between upper blades 305 and 307. That is, the sum of radii of the circles swept out by upper blades 305 and 307 is also smaller than the distance D between the spindles.

However, the circles swept out by the two longer blades do overlap, as viewed from above the mower. That is, the circle swept out by first upper blade 305 overlaps with the circle swept out by second lower blade 306 as viewed from above the mower. Stated another way, the sum of the radii of the circles swept out by the two longer blades (first upper blade 305 and second lower blade 306) is greater that the distance D between the spindles. Vertical clearance is provided between the two long blades (first upper blade 305 and second lower blade 306) to avoid collisions between the longer blades. Clearance is provided between all of the blades, regardless of the relative angular positions of the blades in their respective rotations. As a result of the clearance of lower blades 304 and 306 and upper blades 305 and 307, it is unnecessary to orient the spindle axes in a skewed relationship, as shown in FIG. 1, or to time the blades, as described above in connection with FIG. 2. Thus, in some embodiments, the first and second spindles 301 and 302 are not timed with respect to each other. In other embodiments, the spindles may be timed, although the un-timed arrangement may be preferable, as it avoids the additional structure necessary to insure timing of the spindles.

For the purposes of this disclosure, for spindles to be “timed” in relation to each other means that measures are taken to ensure that the spindles maintain their relative angular positions. For example, the spindles may be driven by a toothed belt running on cogged pulleys, or may be driven by synchronized gears that prevent drift of the angular relationship between the spindles. In particular, driving two spindles using a simple V-belt is not considered to time the spindles. Even though two spindles driven with a simple V-belt may run for long periods with little or no change in their angular relationship, it is possible for the angular relationships to drift due to differences in pulley diameters, wear, slippage of the belt on the pulleys, and the like.

In the example of FIG. 3, the two lower blades cut the bulk of the grass to the cutting height of the lower blades. The small amount of grass that may slip through the horizontal gap between the lower blades without being cut by the lower blades is cut by first upper blade 305 at only a slightly higher cutting height, leaving only an inconsequential and unnoticeable slight irregularity in the cut height of the lawn, as is shown in FIG. 4.

The amount of horizontal and vertical clearance provided may be determined by the expected manufacturing tolerances of the blades, mower deck, spindles, and other mower components, and by the expected stresses that may deform the components during mowing. Preferably, the clearances are made large enough to guarantee that no blade collisions occur during normal operation, but small enough that no noticeable variation in cutting height of the lawn is visible. Although the dimensions and configurations of the blades may vary widely, in some optional embodiments, the longer blades may have a length from 12 to 36 inches, e.g., from 15 to 30 inches, or from 18 to 24 inches. In some embodiments, the shorter blades optionally have a length from 0.05 to 3 inches shorter than the longer blades, e.g., from 0.25 to 2 inches or from 0.5 to 1 inches shorter. The horizontal clearance between the lower blades and/or between the upper blades may be from 0.05 to 2 inches, e.g., from 0.10 to 1 inches or from 0.25 to 0.5 inches. In some embodiments, the vertical clearance between the lower and upper blades on a given spindle may be from 0.02 to 1 inches, e.g., from 0.05 to 0.5 inches or from 0.1 to 0.4 inches. For example, in one embodiment in which the longer blades are 17.375 inches long and the lower blades are 15.815 inches long, the nominal horizontal clearance between the lower blades is 0.030 inches, and the nominal vertical clearance between the lower and upper blades is 0.125 inches. Other blade lengths and clearance dimensions may be used as well.

It will be recognized that the placement of the blades on the two spindles is completely arbitrary. While FIG. 3 shows a shorter lower blade on spindle 301 and a longer lower blade on spindle 302, this arrangement could be reversed if desired.

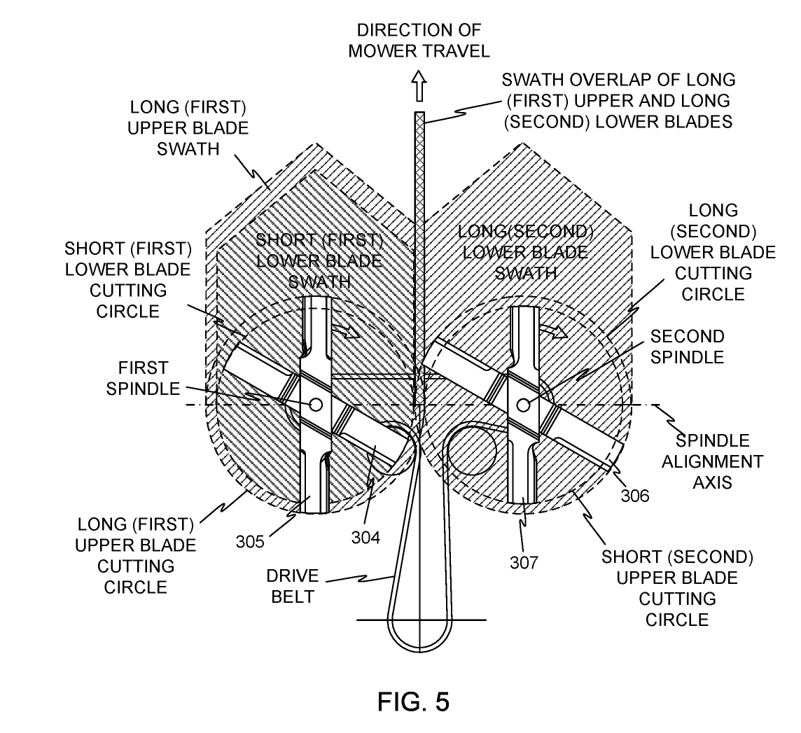

FIG. 5 shows the operation of the blade arrangement of FIG. 3, as viewed from above the mower. An area of overlap exists between the swaths cut by first (long) upper blade 305 and second (long) lower blade 306. The blades may be driven by a prime mover, for example a gasoline or electric motor, through a drive belt, which may be for example a simple V-belt. In the example of FIG. 5, the spindles are placed on an axis that is transverse to the direction of travel of the mower, but this is not a requirement. In other embodiments, the axis on which the spindles are placed may be skewed with respect to the mower travel direction. The transverse axis design may be preferable, as it may allow production of a mower that is shorter in its travel direction than a mower using a skewed spindle mounting axis.

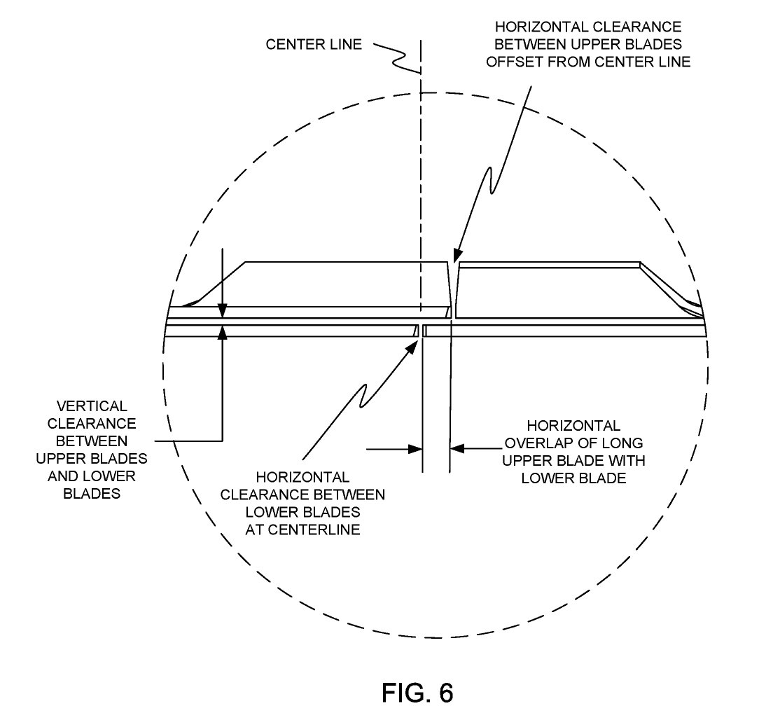

In the example of FIGS. 3-5, the two long blades (first upper blade 305 and second lower blade 306) are equal in length, and the two short blades (first lower blade 304 and second upper blade 307) are equal in length, although this is not a requirement. In other embodiments, different lengths may be used. For example, FIG. 6 is similar to FIG. 4, and shows an enlarged view of the blade interaction in an embodiment in which the two lower blades are equal in length and the upper blades differ in length to provide the overlap between the longer upper blade and the gap between the lower blades. In the embodiment of FIG. 6, the lower blades are symmetrical about the mower center line, so that their point of closest approach is at the centerline. The upper blades still differ in length. As compared with the embodiment of FIG. 4, the embodiment of FIG. 6 may have the advantage that fewer unique blade types are used, as the two lower blades may be identical. Similarly, in other embodiments, the two upper blades may be made identical to each other, and the cutting overlap may be provided by lower blades of differing lengths.

As is also shown in FIG. 5, each set of lower and upper blades are fixed to each other, and rotate together on their respective spindles. The upper blades “lead” the lower blades in rotation, and may pre-cut the grass to one height before the final cut performed by the lower blades. This pre-cutting process may beneficially result in improved grass pulverization, which can facilitate grass deterioration over a shorter period of time. This arrangement, however, is also not required. In other embodiments, the lower blades may lead the upper blades. In still other embodiments, the upper and lower blades need not be fixed to each other, and need not rotate together, and in fact could rotate in opposite directions.

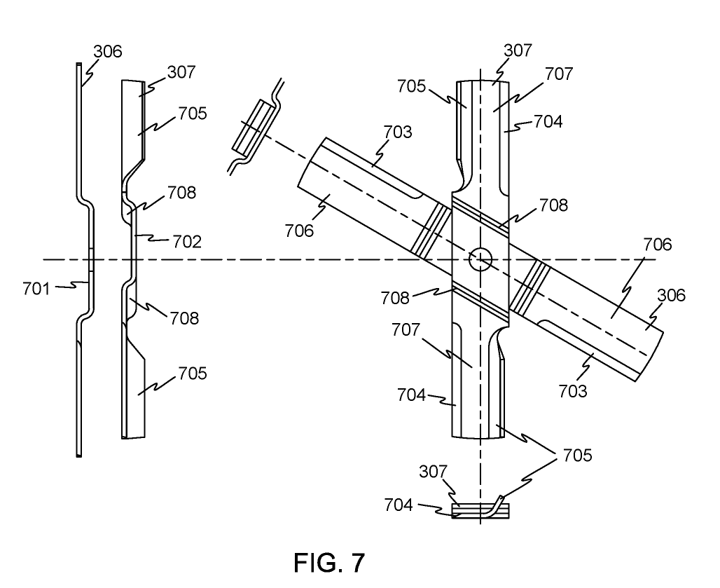

FIG. 7 illustrates one example way of fixing the upper and lower blades to each other, in accordance with some embodiments of the invention. While FIG. 7 illustrates the blade connection using the second lower and upper blades, a similar technique may be used for other blade sets. In this technique, lower blade 306 includes coplanar end portions 706 and an offset portion 701 between end portions 706. Offset portion 701 is planar and parallel to the planar end portions. Upper blade 307 includes two planar end portions 707 and an offset portion 702 between the end portions 707. Offset portion 701 is preferably deeper than offset portion 702, so that the ends of upper blade 307 are held above lower blade 306, providing the vertical clearance between them. The sides 708 of offset portion 702 of upper blade 307 are at an angle to the longitudinal axis of upper blade 307 such that when the blades are assembled onto the spindle, offset portion 701 is disposed against offset portion 702, locking the blades from relative rotation.

Preferably, each lower blade such as blade 306 has at least one cutting zone 703 at a leading edge of blade 306. Two cutting zones 703 are shown in FIG. 7, on different leading edges, but more or fewer cutting zones may be present. Each cutting zone may be sharpened, for example by grinding, to form a cutting edge. Similarly, upper blade 307 may include one or more cutting zones 704.

In some embodiments, the upper blades such as upper blade 307 may include raised fan wings 705, to lift the grass for cutting and to facilitate discharge of cut grass clippings from the mower. The lower blades, such as lower blades 304 and 306 may lack any raised fan wings. For the purposes of this disclosure, a blade lacking raised fan wings is referred to as flat, even in the presence of raised mounting features such as offset portions 701 or 702.

In the embodiments described thus far, only two sets of blades are present, on two respective spindles. However, in other embodiments, three or more spindles may be present, for example a third spindle having a third lower blade and a third upper blade. The third lower and upper blades may interact with first upper and lower blades 304 and 305, or with second upper and lower blades 306 and 307, such that the mower has an even wider cutting width than the embodiment of FIG. 3, for example. The specific arrangement of the blade sets is arbitrary. For example, the center spindle may have its lower blade longer than its upper blade, with the outer spindles having longer upper and shorter lower blades. Or the center spindle may have its lower blade shorter than its upper blade, with the outer spindles having shorter upper and longer lower blades. In any event, the blades on the third spindle interact with either the blades on the first spindle or the second spindle, in a manner like the interaction of the blades on the first and second spindles. More than three spindles and blade sets may be provided, alternating in the placement of their respective longer and shorter blades.

Also in the embodiments described thus far, the two spindles are held with their rotational axes in a fixed parallel relation to each other, so that the lower blades turn in the same plane. The multi-blade mower is thus substantially rigid, and acts as a large flat cutter. In other embodiments, however, the spindles may be movable with respect to each other, to allow the mower deck to flex to conform to uneven ground. For example, a hinge may be provided having its axis horizontal, substantially parallel to the direction of mower travel, and intersecting the center line shown in FIG. 3 at about the average height of the blades, or at another suitable location. The vertical and horizontal clearances provided between the blades are preferably selected to accommodate the expected flexure of the mower deck without incurring blade collisions. The flexure of the deck may be mechanically limited in the interest of avoiding blade interference as well. A flexing deck may be especially advantageous when three or more spindles and blade sets are present, as the additional mower width increases the likelihood of encountering uneven ground in any particular swath.

It is also not necessary that all of the blade sets in a mower embodying the invention be of similar sizes. For example, in a multi-blade mower having three spindles and three blade sets, the middle blade set may sweep out a larger circle than either of the outer blade sets, or vice versa. For example, the middle blade set could include blades about 24 inches long (with the upper and lower blades being of somewhat different lengths), while the outer blade sets may be only about 18 inches in length. Any suitable combination of blade lengths may be used, and no two blade sets need be the same size.

In still other embodiments, other blade arrangements may be used. For example, referring to FIG. 3, second upper blade 307 may be omitted entirely. In another example, upper blades 305 and 307 may not be single elongated pieces. Instead, in some embodiments, the raised fan wings and additional cutting zones provided by the upper blades may be provided by short blade segments mounted to the respective lower blades by welds, rivets, bolts, or other techniques.

In one embodiment, the upper and lower blades may be removed from the mower and reinstalled in a reversed configuration in order to prolong the life of the blades and/or provide for even wear. Of course, if the blade positions are reversed in this manner it will likely be necessary to do the same with all spindles in order to ensure that that there is no blade contact between the blades on different spindles during normal usage. If the upper and lower blades are attached to one another, the configuration may still be reversible, but it may be necessary to provide cutting zones on both the leading and trailing edge of the blades, since the trailing edge will become the leading edge after the integrated blade assembly has been reversed (assuming the same direction of blade rotation). In addition, in the latter embodiment, it may be necessary for any integrated raised fan wings to be provided in a separate optionally non-cutting blade higher than the other blades or to provide the ability to remove and reinstall any fan wings to ensure they are in the proper orientation for normal usage.

It will be understood that the principles of the invention may be embodied in walk-behind mowers, self-propelled walk-behind mowers, riding mowers, standing mowers, pulled mowers, or other kinds of multi-blade mowers. A blade arrangement embodying the invention, such as those discussed above, is preferably enclosed in a mower deck, which may include baffling and other features to control air flow near the blades and to exhaust grass clippings.

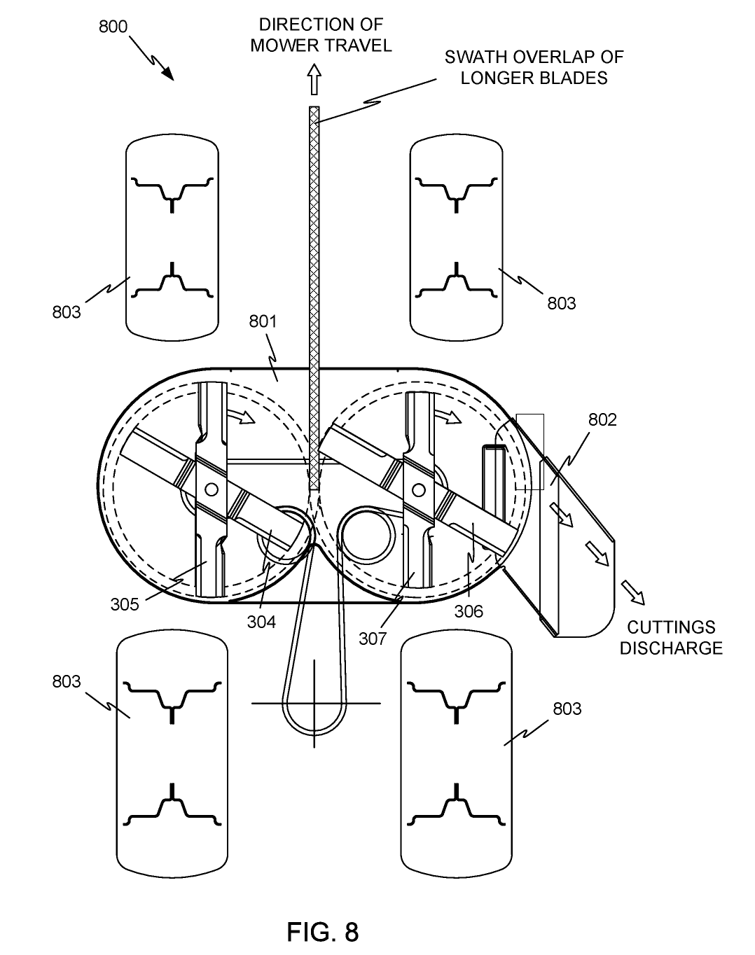

FIG. 8 shows a schematic overhead view of a riding mower 800 according to some embodiments of the invention. Mower 800 includes a deck 801 housing blades 304, 305, 306, and 307 as discussed above. The deck includes an exhaust chute 802, and is carried by four wheels 803.

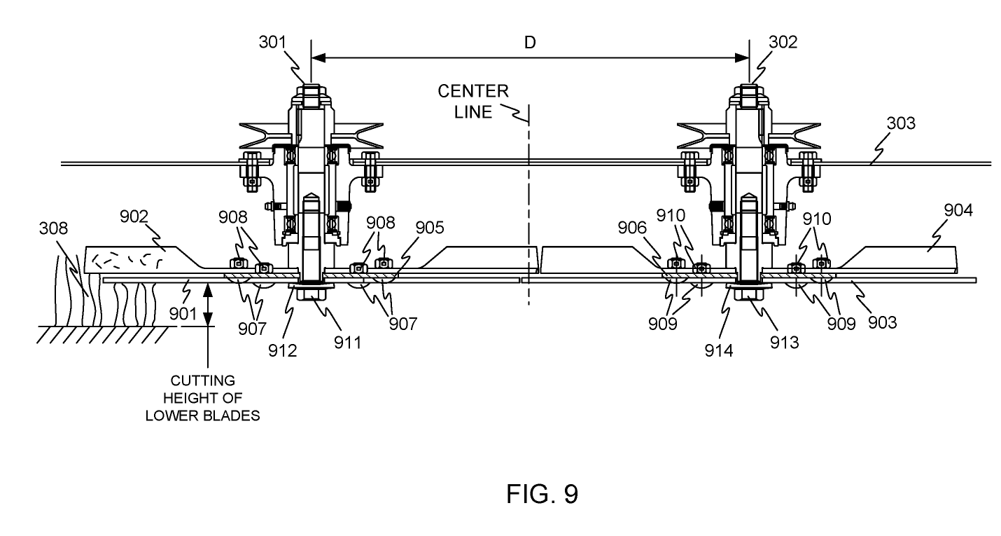

FIG. 9 shows a mower blade arrangement in accordance with other embodiments of the invention, as viewed along the direction of travel of the mower. FIG. 9 is similar in many aspects to FIG. 3, and similar elements are given the same reference numerals in FIG. 9 as in FIG. 3.

As in FIG. 3, a first spindle 301 and a second spindle 302 are spaced apart by a distance D. Spindles 301 and 302 are mounted to a mower deck 303, and turn on bearings.

In this example, four different blades are present, two mounted to each of spindles 301 and 302. A first lower blade 901 and a first upper blade 902 are mounted to and turn on first spindle 301, and a second lower blade 903 and a second upper blade 904 are mounted to and turn on second spindle 302. (The blades on each spindle are shown in FIG. 9 as being aligned parallel with each other for ease of explanation, but this is not necessarily the case in practice. As is explained above, one blade on each axis may lead the other in rotation.)

The height and length relationships of blades 901, 902, 903, and 904 are similar to the relationships of blades 304, 305, 306, and 307 shown in FIG. 3. That is, first upper blade 901 is longer and is mounted higher than first lower blade 901, while second upper blade 904 is shorter and mounted higher than second lower blade 903. All of the height and length variations described above for blades 304, 305, 306, and 307 are also possible for blades 901, 902, 903, and 904, and similar clearances may be provided.

The embodiment of FIG. 9 differs from the embodiment of FIG. 3 in the way that the vertical blade spacing is accomplished. Rather than having offset portions formed in the blades, a first blade spacer 905 is positioned between and in contact with first lower and first upper blades 901 and 902, and a second blade spacer 906 is positioned between and in contact with second lower and second upper blades 903 and 904. The two blade spacers are shown with crosshatching in FIG. 9 for enhanced visibility, although they are not necessarily shown in cross section. Each of blade spacers 905 and 906 is preferably made from flat plate stock of a suitable material such as steel or aluminum. For example, each blade spacer may be stamped, laser cut, plasma cut, or otherwise cut from sheet stock, although other materials and processes may be used. Because the upper and lower blades are in contact with the blade spacers, the thickness of at least portions the blade spacers sets the vertical clearance between the upper and lower blades.

Each of blade spacers 905 and 906 is at least partially flat and has at least a portion of a thickness to provide proper vertical clearance between its respective upper and lower blades. For example, each of blade spacers 905 and 906 may be from 0.02 to 1 inches thick, e.g., from 0.05 to 0.5 inches or from 0.1 to 0.4 inches. In one embodiment, each of blade spacers 905 and 906 is 0.125 inches thick, providing 0.125 inches of vertical clearance between the respective upper and lower blades.

As in the prior embodiments, horizontal clearance between the lower blades and between the upper blades is provided by selecting the lengths of the blades in relation to the spindle spacing D.

First lower blade 901, first upper blade 902, and first blade spacer 905 may be assembled into an integrated unit using bolts 907 and nuts 908, or other kinds of fasteners. Bolts 907 may conveniently be carriage bolts, and nuts 908 may be locking nuts. Similarly, second lower blade 903, second upper blade 904, and second blade spacer 906 may be assembled into an integrated unit using bolts 909 and nuts 910, or by another method.

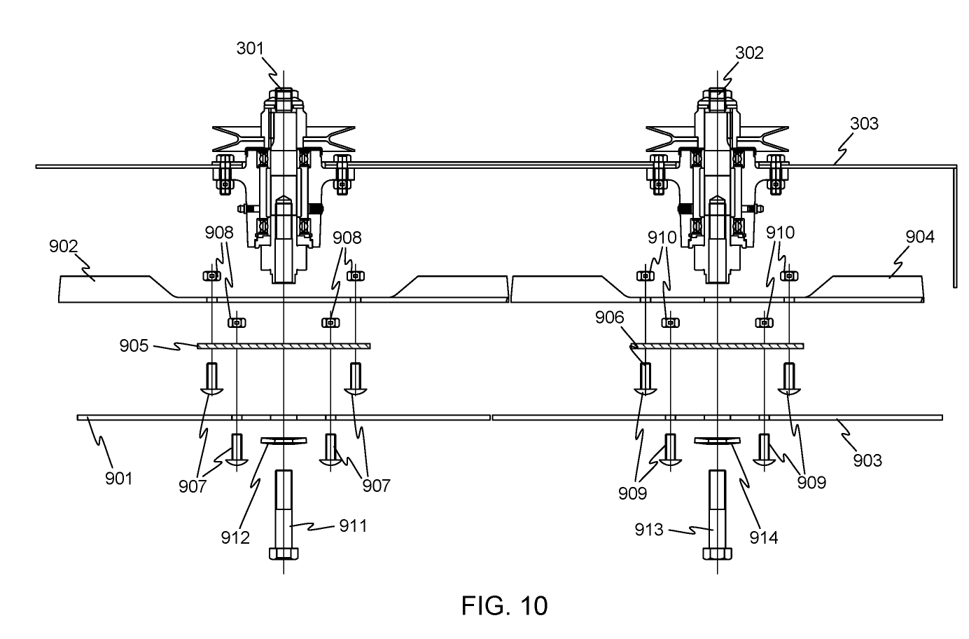

FIG. 10 shows a partially exploded view of the blade arrangement of FIG. 9, and a possible order of assembly. First lower blade 901, first upper blade 902, and first blade spacer 905 may be assembled into their integrated unit using bolts 907 and nuts 908. This integrated unit (shown in more detail in a later figure) may be thought of as a “blade sandwich”, and once assembled, is stiff by virtue of the increased effective moment of inertia of the thick central portion, as compared with the thicknesses of the individual blades or even two coupled blades.

The integrated unit including first lower blade 901, first upper blade 902, and first blade spacer 905 may then be assembled onto first spindle 301 using a bolt 911, or by another suitable method. A washer 912 may be provided between bolt 911 and first lower blade 901. For example, washer 912 maybe a cone washer, a lock washer, or another suitable kind of washer. Preferably, washer 912 assists in preventing bolt 911 from vibrating out of spindle 301.

Similarly, the integrated unit including second lower blade 903, second upper blade 904, and second blade spacer 906 may be assembled onto second spindle 302 using a bolt 913, or by another suitable method. A washer 914, similar to washer 912, may be provided between bolt 913 and second lower blade 903.

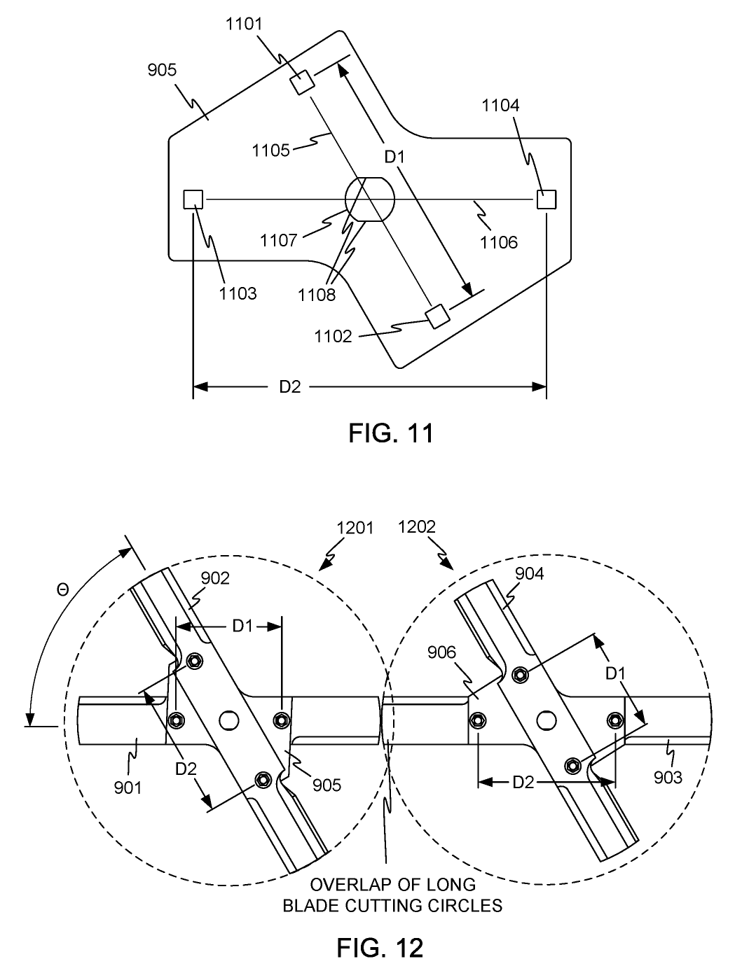

FIG. 11 illustrates a top view of an example embodiment of a blade spacer such as first blade spacer 905. Blade spacer 905 is in the form of an at least partially flat plate, for example as may be stamped or cut from sheet metal stock. Example blade spacer 905 has an asymmetrical pattern of through holes 1101, 1102, 1103, and 1104 for receiving bolts or other fasteners to attach blades to blade spacer 905. Through holes 1101, 1102, 1103, and 1104 may conveniently be square, to accommodate carriage bolts such as bolts 907, but other shapes may be used.

In this example, holes 1101 and 1102 are disposed on an axis 1105 and spaced apart by a distance D1. Similarly, holes 1103 and 1104 are disposed on an axis 1106 and spaced apart by a distance D2. A central hole 1107 is provided for mounting the blade spacer on one of spindles 301 or 302. Central hole 1107 may include a drive feature, preventing rotation of the blade spacer on the spindle. In the example of FIG. 11, central hole 1107 has two flat sides 1108 configured to engage with flats on the shaft of its respective spindle. In other embodiments, central hole 1107 could be square, triangular, or oblong, may be shaped to receive a splined shaft, or may be of another shape usable for preventing turning on a driving shaft inserted into hole 1107.

The shape of blade spacer 905 shown in FIG. 11 is given only by way of example. Other shapes may be used, which may be symmetrical, and which may have hole patterns in different arrangements. The arrangement of FIG. 11 may have the advantages that identical parts can be used for first and second blade spacers 905 and 906, and that the hole patterns may facilitate correct assembly of the blades and spacers.

FIG. 12 shows first and second integrated blade/spacer units (“blade sandwiches”) 1201 and 1202, in accordance with embodiments of the invention, as viewed from above in position as they would be on spindles 301 and 302. In this example, first and second blade spacers 905 and 906 are identical, but spacer 906 is inverted as compared with spacer 905. Short lower blade 901 and short upper blade 904 preferably include bolt holes spaced apart by distance D1, corresponding the spacing of holes 1101 and 1102 in spacer 905 (shown in FIG. 11). Long upper blade 902 and long lower blade 903 preferably include bolt holes spaced apart by distance D2, corresponding the spacing of holes 1103 and 1104 in spacer 905. The difference in D2 and D1 helps ensure proper assembly by ensuring that only one long and one short blade can be attached to the faces of each blade spacer. This may reduce the chance of improper assembly of the mower, helping to ensure that the longer blades will be mounted at different heights and therefore have vertical clearance between them.

In the example of FIG. 12, the hole patterns in blade spacers 905 and 906 are arranged such that upper blades 902 and 904 lead their respective lower blades 901 and 903 in rotation, by an angle Θ. Any suitable angle may be chosen, and the leading/following relationship may be reversed if desired. That is, lower blades 901 and 903 could lead their respective upper blades 902 and 904. The two blade/spacer units 1201 and 1202 need not be arranged in the same way.

The cutting circles of the two blade/spacer units 1201 and 1202 are shown in dashed lines in FIG. 12, showing their horizontal overlap at regions 1203. FIG. 13 shows a horizontally-exploded view of integrated blade/spacer units 1201 and 1202, for additional clarity.

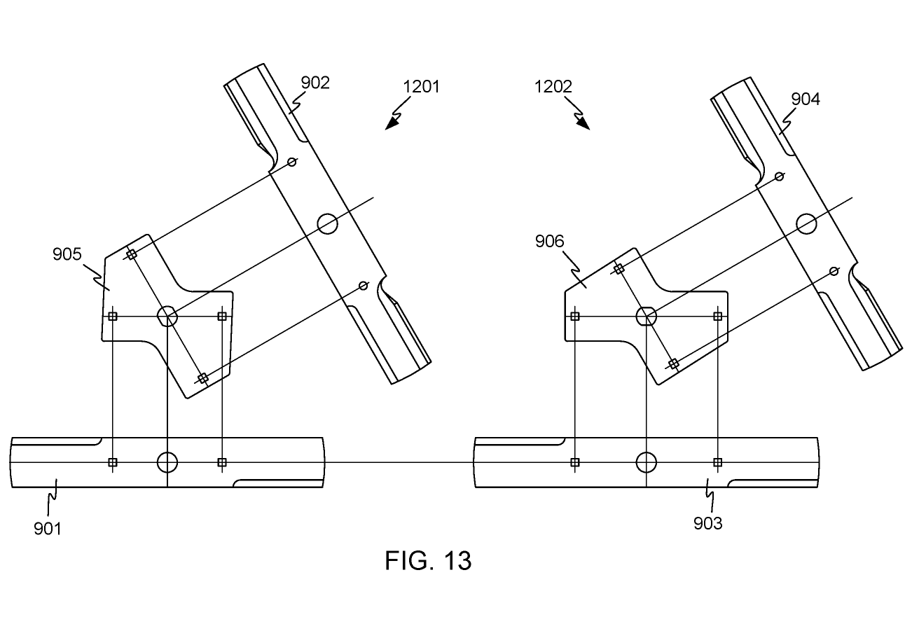

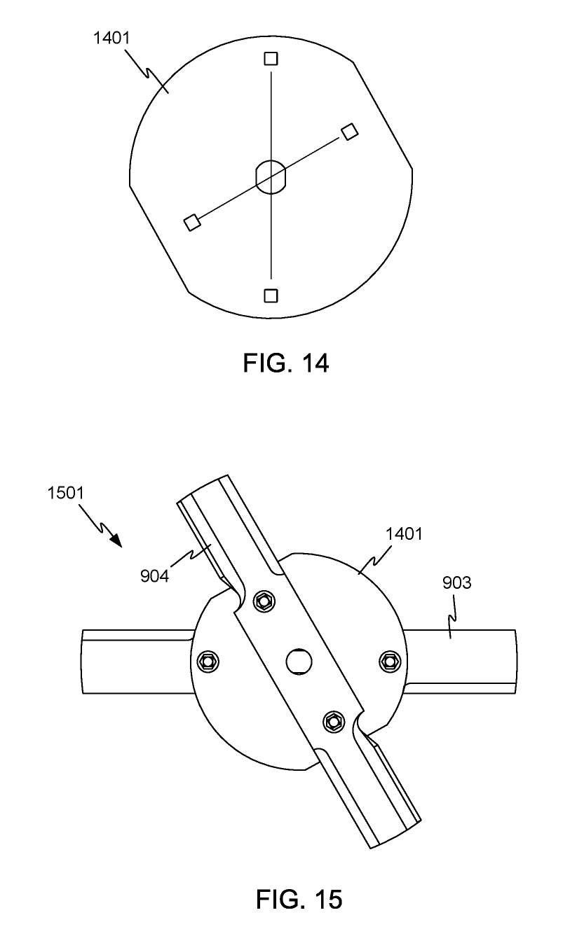

FIG. 14 shows a blade spacer 1401 in accordance with other embodiments of the invention. Spacer 1401 has a generally round shape, illustrating that there is considerable flexibility in choosing the shapes of the spacers. Spacer 1401 includes a hole pattern similar to the hole pattern in spacer 905. FIG. 15 illustrates an integrated blade/spacer unit, using spacer 1401.

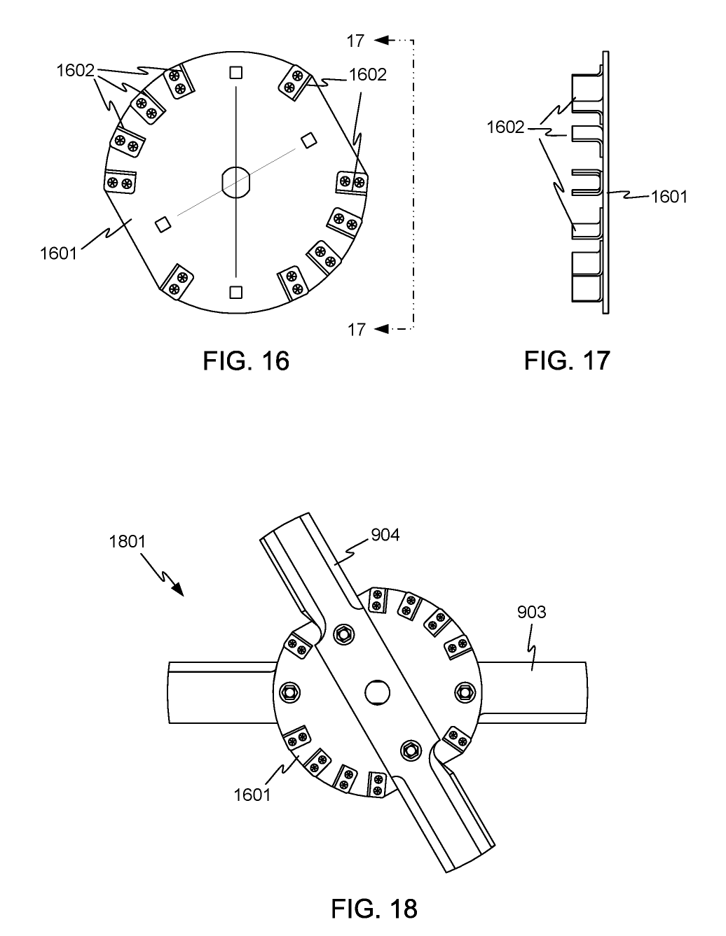

A spacer shaped similar to spacer 1401 may have the advantage that its increased face area may be used for other purposes. FIGS. 16 and 17 illustrate top and side views of a blade spacer 1601, in accordance with embodiments of the invention. Blade spacer 1601 is similar in many respects to blade spacer 1401 discussed above, with the addition of a number of fan blades 1602 (not all of which are labeled). Fan blades 1602 may be made of any durable material, for example steel, and may be attached to blade spacer 1601 in any suitable way, for example by rivets, clinching, welding, or other methods. Fan blades 1602 extend outward from the top face of spacer 1601, and may act to improve air flow and circulation with the mower deck as blade spacer 1601 turns with its respective mower blades.

FIG. 18 illustrates the attachment of mower blades to spacer 1601, to form an integrated blade/spacer unit 1801.

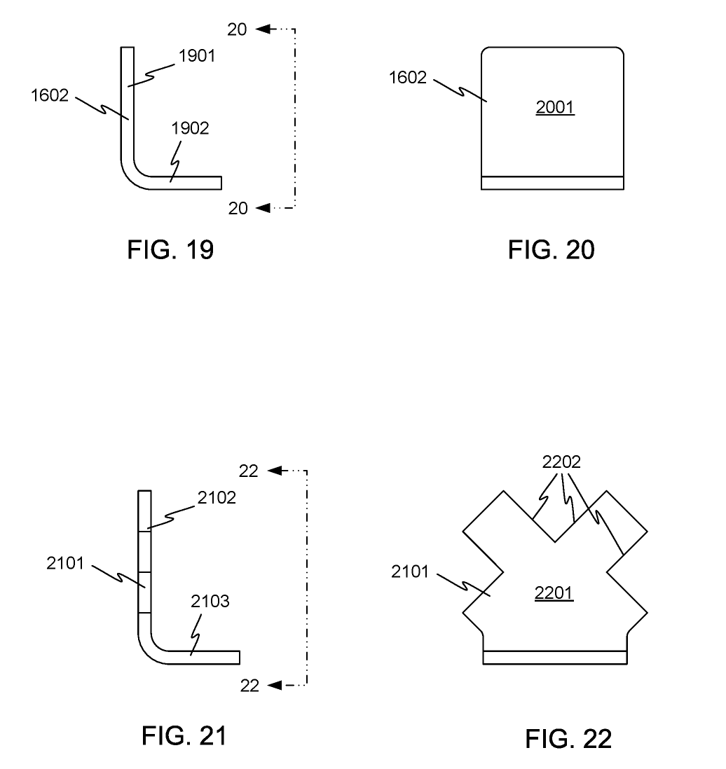

FIGS. 19-22 illustrate some fan blade shapes usable in embodiments of the invention. For example, FIGS. 19 and 20 show end and side views of a fan blade 1602 as shown in FIG. 16. Fan blade 1602 is generally L-shaped, having an upstanding portion 1901 and a base portion 1902, through which rivets or other fasteners may be used to attach fan blade 1602 to a blade spacer such as spacer 1601. While upstanding portion 1901 is shown as being substantially perpendicular to base portion, other angles may be used. Similarly, face 2001 is shown as being generally rectangular, but other shapes are possible.

FIGS. 21 and 22 show end and side views of a fan blade 2101 in accordance with other embodiments of the invention. Like fan blade 1602, fan blade 2101 includes an upstanding portion 2102 and a base portion 2103, by which fan blade 2101 may be attached to a blade spacer such as blade spacer 1601. However, face 2201 has a jagged outer perimeter shape 2202, which may promote mulching of grass clippings before they are ejected from the mower deck. For the purposes of this disclosure, for a shape to be “jagged” means that it is sharply irregular. The shape of FIG. 22 is one example of a jagged shape, composed of a number of short, straight edges with right angles between them. Other examples may include shapes with sawtooth edges, serrated edges, wavy edges, sharply curved edges, short edges with other than right angles between them, or the like. An example of a shape that is not jagged is the shape of fan blade 1602, shown in FIGS. 19 and 20. In general, a jagged shape is one that can promote stress concentrations in grass clippings impacting the edges of the shape, so that the grass clippings may be further cut into smaller pieces (mulched). Although possible, it is not necessary that the edges be additionally sharpened by grinding, filing, or the like. Preferably, the cutting action of the fan blades results from the shape imparted during their original formation, for example by stamping, plasma cutting, laser cutting, or the like.

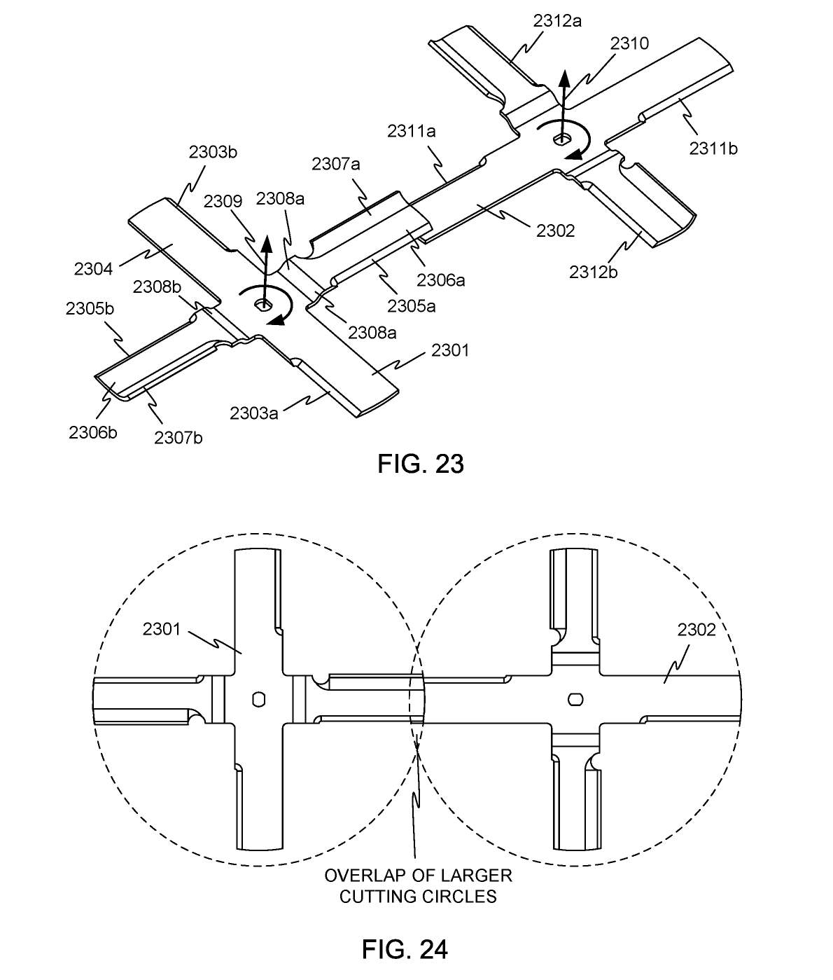

FIG. 23 illustrates a set of blades 2301 and 2302 in accordance with another embodiment of the invention. Blades 2301 and 2302 function similarly to blades 304, 305, 306, and 307 described above and shown in FIG. 3, but are constructed differently and thus require fewer discrete parts. Each of blades 2301 and 2302 is made from a single, monolithic piece of material, for example carbon steel, and includes upper and lower cutters that function similarly to the separate upper and lower blades described above. Blade 2301 may be thought of as a single blade with four cutting edges, or may be thought of as two blades, similar to blades 304 and 305, formed from a single piece of material. Similarly, blade 2302 may be thought of as a single blade with four cutting edges, or may be thought of as two blades, similar to blades 306 and 307, formed from a single piece of material. In the discussion below, each of blades 2301 and 2302 is described as a single blade with four cutting edges.

For example, blade 2301 includes two lower cutting edges 2303a and 2303b on a lower portion 2304 of blade 2301. Two upper cutting edges 2305a and 2305b are positioned on upper portions 2306a and 2306b of blade 2301. Upper portions 2306a and 2306b also include raised wings 2307a and 2307b.

Blade 2301 is made of a single piece of material, for example by stamping or another suitable process. Upper portions 2306a and 2306b are raised in the fabrication process by bending the material of blade 2301 at breaks 2308a and 2308b. Wings 2307a and 2307b may be turned upward at the same time or in a later operation. Cutting edges 2303a, 2303b, 2305a, and 2305b may be formed by grinding blade 2301. Preferably, cutting edges 2303a and 2303b of lower portion 2034 are in a similar height relationship to cutting edges 2305a and 2305b as the cutting edges of blades 304 and 305. Other features may be present, for example ribs, gussets, or other stiffening features, which are preferably stamped or otherwise formed into blade 2301 at the time of its manufacture.

The “spokes” of blade 2301 are at right angles to each other, so that they are angularly spaced 90 degrees apart in the rotation of blade 2301 about axis 2309, although this is not a requirement. Other angular relationships may be used, for example similar to the relationships shown in FIG. 7. Axis 2309 corresponds to the axis of a spindle (not shown) on which blade 2301 may be mounted.

In blade 2301, upper cutting edges 2305a and 2305b extend farther from axis 2309 than do lower cutting edges 2303a and 2303b. Upper cutting edges 2305a and 2305b therefore sweep out a larger cutting circle than lower cutting edges 2303a and 2303b. This relationship is similar to the relationship of blades 304 and 305 discussed above, in which upper blade 305 is longer than lower blade 304.

Blade 2302 is similar to blade 2301, except that the length relationship of the lower and upper portions is reversed. In blade 2302, the lower cutting edges 2311a and 2311b extend farther from axis 2310 than the upper cutting edges 2312a and 2312b, and thus lower cutting edges 2311a and 2311b sweep out a larger cutting circle than upper cutting edges 2312a and 2312b. In some embodiments, blades 2301 and 2302 can be fabricated using much of the same tooling.

The cutting circle relationships are illustrated in the upper orthogonal view of FIG. 24. As in the earlier embodiments, the cutting circles of the lower portions of blades 2301 and 2302 do not overlap, and horizontal clearance exists between the lower portions regardless of the angular relationship of blades 2301 and 2302. Similarly, the cutting circles of the upper portions of blades 2301 and 2302 do not overlap, and horizontal clearance exists between the upper portions regardless of the angular relationship of blades 2301 and 2302. However, the cutting circle swept out by the longer upper portion does overlap with the cutting circle swept out by the longer lower portions.

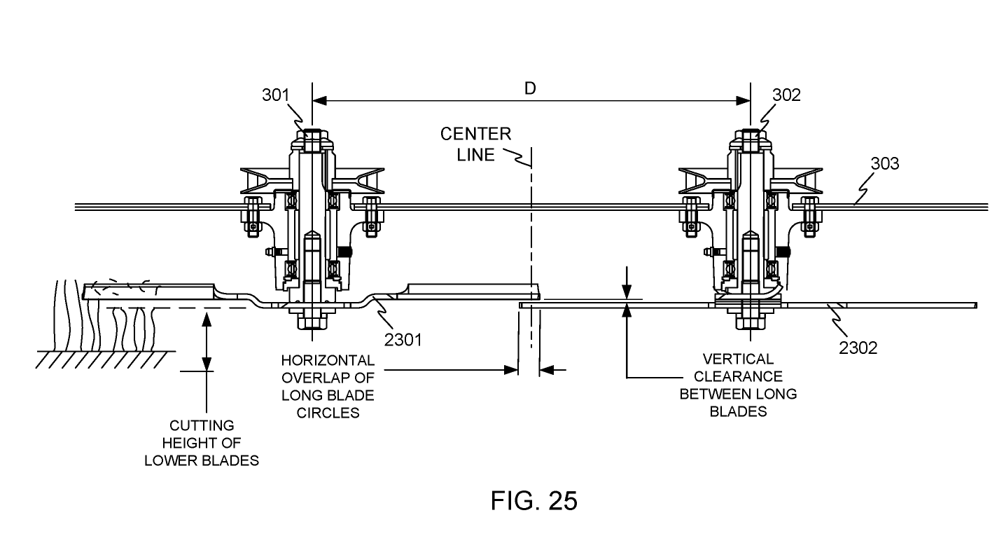

FIG. 25 shows blades 2301 and 2302 mounted to spindles 301 and 302, under mower deck 303. The cutting circle radii and vertical and horizontal clearances provided may be similar to those described above for the embodiments in which separate multiple blades are used. For example, in some optional embodiments, the cutting circle diameters of the cutting edges extending farthest from the spindles (analogous to the longer blades in the above embodiments) may be from 12 to 36 inches, e.g., from 15 to 30 inches, or from 18 to 24 inches. In some embodiments, the cutting circle diameters for of the cutting edges extending less far from the spindles (analogous to the shorter blades in the above embodiments) may optionally be from 0.05 to 3 inches smaller than the larger cutting circles, e.g., from 0.25 to 2 inches or from 0.5 to 1 inches smaller. The horizontal clearance between the lower portions and/or between the upper portions may be from 0.02 to 2 inches, e.g., from 0.10 to 1 inches or from 0.25 to 0.5 inches. In some embodiments, the vertical clearance between the cutting edges on the lower and upper blades on a given spindle may be from 0.02 to 1 inches, e.g., from 0.05 to 0.5 inches or from 0.1 to 0.4 inches. For example, in one embodiment in which the longer portions sweep out a circle 17.375 inches in diameter and the shorter portions sweep out a circle 15.815 inches in diameter, the nominal horizontal clearance between the lower portions is 0.030 inches, and the nominal vertical clearance between the lower and upper portions is 0.125 inches. Other cutting circle sizes and clearance dimensions may be used as well.

As in the previous embodiments, more than two spindles may be present. For example, a third spindle may be present with a blade similar to blade 2301 or blade 2302, and spaced similarly from its adjacent spindle. More spindles may be provided, with blades similar to blades 2301 and 2302 being mounted in alternating arrangement, to provide horizontal and vertical clearance between all adjacent blades.

The invention has now been described in detail for the purposes of clarity and understanding. However, those skilled in the art will appreciate that certain changes and modifications may be practiced within the scope of the appended claims. It is to be understood that any workable combination of the features and capabilities disclosed above in the various embodiments is also considered to be disclosed.

What is claimed is:

1. A mower, comprising:
a spindle;
a lower blade defining a first pair of through holes spaced apart by a first distance;
an upper blade defining a second pair of through holes spaced apart by a second distance different from the first distance; and
a spacer between the first lower and first upper blades, the spacer being at least partially flat and defining a pattern of through holes for receiving fasteners to connect the lower blade, the spacer, and the upper blade into an integrated unit with the lower and upper blades separated vertically from each other by a distance equal to a thickness of the spacer;
wherein the hole pattern comprises a third first pair of through holes spaced apart by the first distance for attaching the lower blade, and a fourth pair of through holes spaced apart by the second distance for attaching the upper blade.

2. The mower of claim 1, wherein the pattern of through holes is such that when the lower blade, the spacer, and the upper blade are assembled into the integrated unit, the lower and upper blades are fixed in an angular relationship such that one leads the other in rotation of the spindle.

3. The mower of claim 1, wherein the spacer further defines a central drive feature for receiving the spindle, the drive feature preventing rotation of the spacer with respect to the spindle.

4. The mower of claim 3, wherein the drive feature is a hole with at least one flat side or shaped to receive a splined shaft.

5. The mower of claim 1, wherein the upper and lower blades are of unequal length.

6. The mower of claim 1, further comprising a plurality of fan blades attached to the spacer.

7. The mower of claim 6, wherein at least some of the fan blades have a shape that promotes mulching of cut grass clippings.

8. A multi-blade mower, comprising:
first and second spindles spaced apart from each other by a distance;
a first lower blade and a first upper blade mounted to the first spindle, wherein the first upper blade is mounted higher than the first lower blade;
a second lower blade and a second upper blade mounted to the second spindle, wherein the second lower blade is at the same height as the first lower blade, wherein the second upper blade is mounted higher than the second lower blade;
a first spacer between the first lower and first upper blades, the first spacer defining a pattern of through holes for receiving fasteners to connect the first lower blade, the first spacer, and the first upper blade into a first integrated unit with the first lower and first upper blades separated vertically from each other by a distance equal to a thickness of the first spacer; and
a second spacer between the second lower and second upper blades, the second spacer defining a pattern of through holes for receiving fasteners to connect the second lower blade, the second spacer, and the second upper blade into a second integrated unit with the second lower and second upper blades separated vertically from each other by a distance equal to a thickness of the second spacer.

9. The multi-blade mower of claim 8, wherein:
the first upper blade is longer than the first lower blade and sweeps out a larger circle than the first lower blade sweeps out during rotation;
the second upper blade is shorter than the second lower blade and sweeps out a smaller circle than the second lower blade sweeps out during rotation; and
the circles swept out by the first and second lower blades do not overlap, and the circles swept out by the first upper blade and the second lower blade do overlap, as viewed from above the mower.

10. The multi-blade mower of claim 8, wherein each of the first and second spacers is at least partially flat.

11. The multi-blade mower of claim 10, wherein the first spacer and the second spacer are identical to each other, have an asymmetrical hole pattern, and are assembled to their respective spindles such that the first and second spacers are inverted with respect to each other.

12. The multi-blade mower of claim 8, wherein the hole pattern in each of the first and second spacers comprises a first pair of holes spaced apart by a first distance for attaching the respective longer blade, and a second set of holes spaced apart by a second distance different from the first for attaching the respective shorter blade.

13. The multi-blade mower of claim 8, wherein each of the first and second spacers further defines a central drive feature for receiving the respective first or second spindle, the drive feature preventing rotation of the spacer with respect to the received spindle.

14. The multi-blade mower of claim 13, wherein each drive feature is a hole with at least one flat side or shaped to receive a splined shaft.

15. The multi-blade mower of claim 8, further comprising a plurality of fan blades, wherein the fan blades are attached to the first spacer, or the fan blades are attached to the second spacer, or some of the fan blades are attached to the first spacer and some of the fan blades are attached to the second spacer.

16. The multi-blade mower of claim 15, where at least some of the fan blades have a shape that promotes mulching of cut grass clippings.

17. A multi-blade mower, comprising:
first and second spindles spaced apart from each other by a distance;
a first lower blade and a first upper blade mounted to the first spindle, wherein the first upper blade is mounted higher than the first lower blade, and wherein the first upper blade is longer than the first lower blade and sweeps out a larger circle than the first lower blade sweeps out during rotation, and wherein the first lower blade and the first upper blade are formed together from a first single piece of material;
a second lower blade and a second upper blade mounted to the second spindle, wherein the second lower blade is at the same height as the first lower blade, wherein the second upper blade is mounted higher than the second lower blade, and wherein the second upper blade is shorter than the second lower blade and sweeps out a smaller circle than the second lower blade sweeps out during rotation, and wherein the second lower blade and the second upper blade are formed together from a second single piece of material; and
wherein the circles swept out by the first and second lower blades do not overlap, and the circles swept out by the first upper blade and the second lower blade do overlap, as viewed from above the mower.

18. A multi-blade mower, comprising:
first and second spindles spaced apart from each other by a distance;
a first blade mounted to the first spindle, wherein the first blade comprises a first set of upper cutting edges and a first set of lower cutting edges, the first sets of upper and lower cutting edges displaced rotationally about the first spindle, and wherein the first upper cutting edges are higher than the first lower cutting edges, and wherein the first upper cutting edges extend farther from the first spindle than the first lower cutting edges and sweep out a larger circle than the first lower cutting edges sweep out during rotation of the first spindle, and wherein the first blade, including the first sets of upper cutting edges and lower cutting edges, is formed from a first single piece of material;
a second blade mounted to the second spindle, wherein the second blade comprises a second set of upper cutting edges and a second set of lower cutting edges, the second sets of upper and lower cutting edges being displaced rotationally about the second spindle, wherein the second upper cutting edges are higher than the second lower cutting edges and the second set of lower cutting edges is at the same height as the first set of lower cutting edges, wherein the second lower cutting edges extend farther from the second spindle than the second upper cutting edges and sweep out a larger circle than the second upper cutting edges sweep out during rotation of the second spindle, and wherein the second blade, including the second sets of upper cutting edges and lower cutting edges, is formed from a second single piece of material; and
wherein the circles swept out by the first and second sets of lower cutting edges do not overlap, and the circles swept out by the first set of upper cutting edges and the second set of lower cutting edges do overlap, as viewed from above the mower.

19. The multi-blade mower of claim 18, wherein the first and second spindles are not timed in relation to each other.

20. The multi-blade mower of claim 18, wherein the first and second spindles are positioned on an axis that is perpendicular to a nominal direction of travel of the mower.
